(19) United States
(12) Patent Application Publication
(10) Pub. No.: US 2025/0003791 A1
(43) Pub. Date: Jan. 2, 2025

(54) OPTICAL FIBER SENSING SYSTEM, OPTICAL FIBER SENSING APPARATUS, AND ROUTE DETERMINATION METHOD

(71) Applicant: NEC Corporation, Tokyo (JP)

(72) Inventors: Tadayuki IWANO, Tokyo (JP); Yoshiaki AONO, Tokyo (JP); Yoshinori KITAHARA, Tokyo (JP)

(21) Appl. No.: 18/750,009

(22) Filed: Jun. 21, 2024

(30) Foreign Application Priority Data
Jun. 27, 2023 (JP) 2023-105101

(51) Int. Cl. G01H 9/00; G01B 11/02; G01D 5/353

(52) U.S. Cl. CPC G01H 9/004; G01B 11/026; G01D 5/35358

(57) ABSTRACT

A method includes: a step of transmitting pulsed light to an optical fiber buried in the ground, and also receiving an optical signal from the optical fiber; a step of extracting, for each of the plurality of manholes, a detection result of the hitting sound by the optical fiber at a time when the manhole is hit, based on the pulsed light and the optical signal, and deciding whether the manhole is located on a laying route of the optical fiber, based on the detection result; and a step of determining, for each manhole located on the laying route, a distance of the optical fiber from a location of the optical fiber sensing apparatus to a location of the manhole, based on the detection result, and determining the laying route, based on a distance of the optical fiber of a manhole on the laying route.

### INCORPORATION BY REFERENCE

This application is based upon and claims the benefit of priority from Japanese patent application No. 2023-105101, filed on Jun. 27, 2023, the disclosure of which is incorporated herein in its entirety by reference.

### TECHNICAL FIELD

The present disclosure relates to an optical fiber sensing system, an optical fiber sensing apparatus, and a route determination method.

### BACKGROUND ART

In optical fiber sensing using an optical fiber as a sensor, the optical fiber can detect sound and vibration. Thus, in recent years, by utilizing a characteristic of such optical fiber sensing, a study for using optical fiber sensing for various applications has been proceeded.

For example, in a technique disclosed in Japanese Unexamined Patent Application Publication No. 2020-052030, hitting is applied to a manhole on a path of an optical fiber, vibration generated by the hitting is decided by using optical fiber sensing, and thereby a hitting position on the optical fiber is determined. Then, the hitting position on the optical fiber and a position on a map of the manhole subjected to the hitting are associated to each other.

Then, in recent years, there has been a demand for determining a laying route of an optical fiber. Further, an optical fiber may pass under a manhole when being buried in the ground.

Thus, as in the technique disclosed in Japanese Unexamined Patent Application Publication No. 2020-052030, there is a possibility that a laying route of an optical fiber can be determined by hitting a manhole.

However, the technique disclosed in Japanese Unexamined Patent Application Publication No. 2020-052030 is to associate, by hitting a manhole, a hitting position on an optical fiber and a position on a map of the manhole subjected to the hitting to each other, on a premise that the position of the manhole on the map is clear. Thus, the technique disclosed in Japanese Unexamined Patent Application Publication No. 2020-052030 cannot determine a laying route of an optical fiber being unknown.

### SUMMARY

Therefore, in view of the above-described problem, an example object of the present disclosure is to provide an optical fiber sensing system, an optical fiber sensing apparatus, and a route determination method that are capable of determining a laying route of an optical fiber.

In a first example aspect, an optical fiber sensing system includes:
an optical fiber configured to be buried in the ground and detect a hitting sound at a time when each of a plurality of manholes is hit in order;
at least one memory configured to store an instruction group; and
at least one processor configured to execute the instruction group in such a way as to
control a communication unit in such a way as to transmit pulsed light to the optical fiber, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

In a second example aspect, an optical fiber sensing apparatus includes:
at least one memory configured to store an instruction group; and
at least one processor configured to execute the instruction group in such a way as to
control a communication unit in such a way as to transmit pulsed light to an optical fiber configured to be buried in the ground and detect a hitting sound at a time when each of a plurality of manholes is hit in order, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

In a third example aspect, a route determination method is a method by an optical fiber sensing apparatus, and includes:
a communication step of transmitting pulsed light to an optical fiber configured to be buried in the ground and detect a hitting sound at a time when each of a plurality of manholes is hit in order, and also receiving an optical signal from the optical fiber;
an extraction step of extracting, for each of the plurality of manholes, a detection result of the hitting sound by the optical fiber at a time when the manhole is hit, based on the pulsed light and the optical signal;
a decision step of deciding, for each of the plurality of manholes, whether the manhole is located on a laying route of the optical fiber, based on a detection result of the hitting sound at a time when the manhole is hit; and
a determination step of determining, for each manhole located on a laying route of the optical fiber, a distance of the optical fiber from a location of the optical fiber sensing apparatus to a location of the manhole, based on a detection result of the hitting sound at a time when the manhole is hit, and determining a laying route of the optical fiber, based on a distance of the optical fiber of a manhole on a laying route of the optical fiber.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating a configuration example of an optical fiber sensing system according to a first example embodiment;

FIG. 2 is a diagram for describing a specific operation example of an optical fiber sensing apparatus according to the first example embodiment;

FIG. 3 is a diagram for describing a specific operation example of the optical fiber sensing apparatus according to the first example embodiment;

FIG. 4 is a flowchart for describing an example of a flow of a schematic operation of the optical fiber sensing apparatus according to the first example embodiment;

FIG. 5 is a diagram illustrating a configuration example of an optical fiber sensing system according to a second example embodiment;

FIG. 6 is a diagram illustrating an example of a GUI screen in which a laying route of an optical fiber and a plurality of manholes are mapped on a map, the GUI screen being displayed on a display unit according to the second example embodiment;

FIG. 7 is a flowchart for describing an example of a flow of a schematic operation of an optical fiber sensing apparatus according to the second example embodiment; and

FIG. 8 is a block diagram illustrating a hardware configuration example of a computer achieving the optical fiber sensing apparatus according to the first and second example embodiments.

### EXAMPLE EMBODIMENT

Hereinafter, example embodiments of the present disclosure will be described with reference to the drawings. Note that, the following description and the drawings are omitted and simplified as appropriate for clarity of description. Further, in the following drawings, the same elements are denoted by the same reference signs, and redundant descriptions are omitted as necessary.

### First Example Embodiment

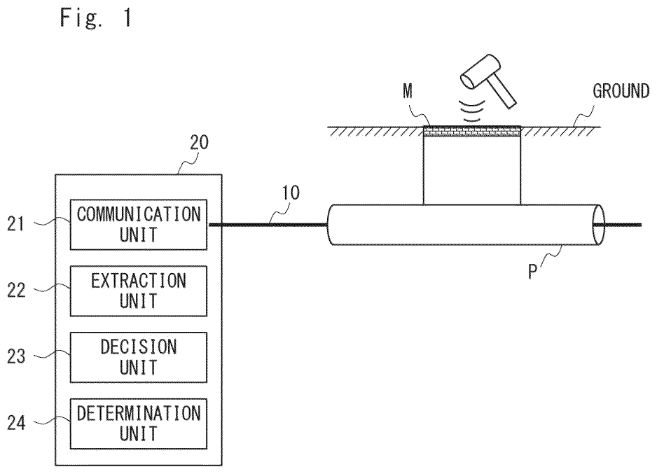

First, a configuration example of an optical fiber sensing system according to a first example embodiment will be described with reference to FIG. 1.

As illustrated in FIG. 1, the optical fiber sensing system according to the first example embodiment includes an optical fiber 10 and an optical fiber sensing apparatus 20.

The optical fiber 10 is buried in the ground. In the example in FIG. 1, the optical fiber 10 is buried in the ground in such a mode as to be passed through a buried pipeline P buried in the ground. However, a laying mode of the optical fiber 10 is not limited to a mode of passing through the buried pipeline P.

Further, one end of the optical fiber 10 is connected to the optical fiber sensing apparatus 20.

The optical fiber sensing apparatus 20 is achieved by, for example, a sensing apparatus such as a distributed fiber optic sensing (DFOS) apparatus, and includes a communication unit 21, an extraction unit 22, a decision unit 23, and a determination unit 24.

The communication unit 21 transmits pulsed light to the optical fiber 10. Further, the communication unit 21 receives, from the optical fiber 10, as an optical signal, backscattered light generated by transmitting the pulsed light through the optical fiber 10.

In the first example embodiment, for example, a user hits each of a plurality of manholes M in order with a hammer or the like. Then, a laying route of the optical fiber 10 is determined by using a hitting sound at a time when each of the plurality of manholes M is hit.

When the optical fiber 10 passes under the manhole M, it can be said that the manhole M is located on the laying route of the optical fiber 10. The hitting sound at a time when the manhole M located on the laying route of the optical fiber 10 is hit is propagated to the optical fiber 10. As a result, a characteristic (e.g., a wavelength) of an optical signal transmitted through the optical fiber 10 changes. Thus, the optical fiber 10 is capable of detecting the hitting sound at a time when the manhole M is hit.

The extraction unit 22 extracts, for each of the plurality of hit manholes M, a detection result of the hitting sound by the optical fiber 10 at a time when the manhole M is hit, based on pulsed light transmitted to the optical fiber 10 by the communication unit 21 and an optical signal received from the optical fiber 10 by the communication unit 21.

Herein, the extraction unit 22 can determine a distance of the optical fiber 10 from a location of the optical fiber sensing apparatus 20 (the communication unit 21) to a location where an optical signal is generated, based on a time difference between a time when pulsed light is transmitted to the optical fiber 10 and a time when the optical signal is received from the optical fiber 10. Further, when the characteristic of the optical signal is changed, the extraction unit 22 can determine that the hitting sound at a time when the manhole M is hit is detected by the optical fiber 10 at the distance. Further, the extraction unit 22 can determine intensity of the hitting sound according to a degree of change in the characteristic of the optical signal.

Then, for example, the extraction unit 22 may extract, as a detection result of the hitting sound, an acoustic characteristic indicating the intensity of the hitting sound detected by the optical fiber 10 at each distance of the optical fiber 10 from the location of the optical fiber sensing apparatus 20 (the communication unit 21) to the location where the hitting sound is detected by the optical fiber 10.

The decision unit 23 decides, for each of the plurality of hit manholes M, whether the manhole M is located on the laying route of the optical fiber 10, based on a detection result of the hitting sound by the optical fiber 10 at a time when the manhole M is hit.

The determination unit 24 determines, for each manhole M located on the laying route of the optical fiber 10 among the plurality of hit manholes M, the distance of the optical fiber 10 from the location of the optical fiber sensing apparatus 20 (the communication unit 21) to the location of the manhole M, based on a detection result of the hitting sound by the optical fiber 10 at a time when the manhole M is hit.

Furthermore, the determination unit 24 determines the laying route of the optical fiber 10, based on the distance of the optical fiber 10 of the manhole M located on the laying route of the optical fiber 10. At this time, for example, the determination unit 24 may determine the laying route of the optical fiber 10, based on a relative magnitude relationship of the distance of the optical fiber 10 between the manholes M located on the laying route of the optical fiber 10.

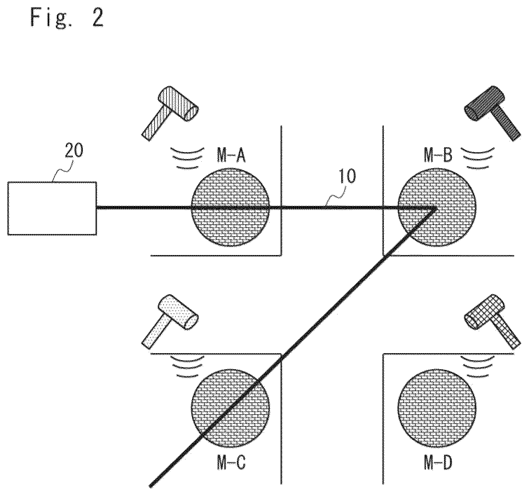

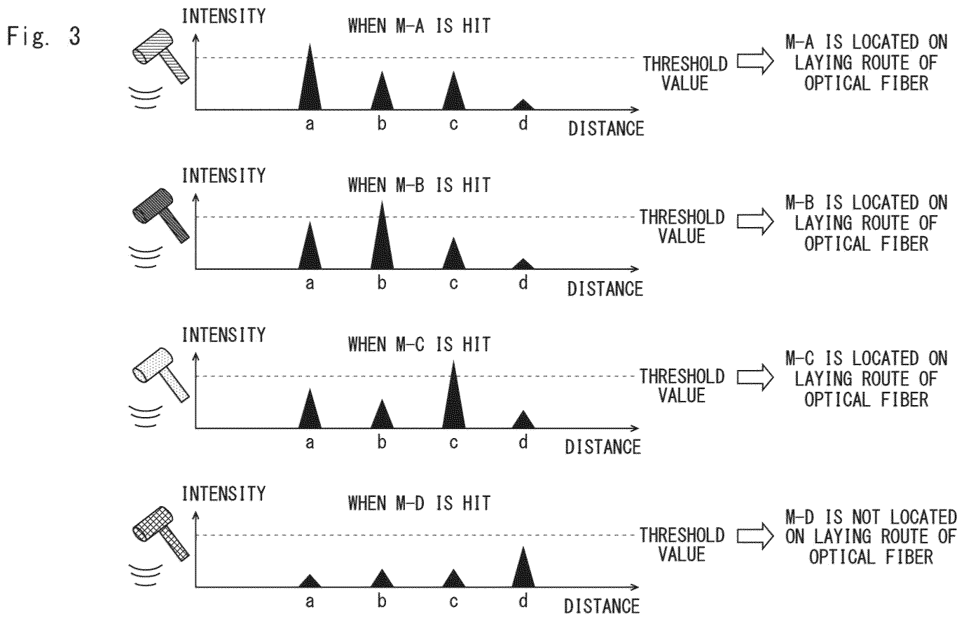

Subsequently, a specific operation example of the optical fiber sensing apparatus 20 according to the first example embodiment will be described with reference to FIGS. 2 and 3.

Herein, as illustrated in FIG. 2, it is assumed that a laying route of the optical fiber 10 is determined by using the hitting sound at a time when each of four manholes M-A, M-B, M-C, and M-D installed at an intersection or the like is hit.

Further, herein, it is assumed that the extraction unit 22 extracts each of acoustic characteristics as illustrated in FIG. 3, respectively, as detection results of the hitting sound by the optical fiber 10 at a time when each of the four manholes M-A, M-B, M-C, and M-D is hit. Note that, in each acoustic characteristic illustrated in FIG. 3, a horizontal axis indicates a distance of the optical fiber 10 from the location of the optical fiber sensing apparatus 20 (communication unit 21), and a vertical axis indicates intensity of the hitting sound detected by the optical fiber 10 at that distance.

As illustrated in FIG. 3, in the acoustic characteristic at a time when the manhole M-A is hit, the intensity of the hitting sound is equal to or greater than a threshold value at a distance a of the optical fiber 10.

Therefore, the decision unit 23 decides that the manhole M-A is located on the laying route of the optical fiber 10.

Further, the determination unit 24 determines that a location of the manhole M-A is a location being equivalent to the distance a of the optical fiber 10. In other words, the determination unit 24 determines that the distance of the optical fiber 10 from the location of the optical fiber sensing apparatus 20 (the communication unit 21) to the location of the manhole M-A is the distance a.

Further, in the acoustic characteristic at a time when the manhole M-B is hit, the intensity of the hitting sound is equal to or higher than the threshold value at a distance b of the optical fiber 10. Therefore, the decision unit 23 decides that the manhole M-B is located on the laying route of the optical fiber 10. Further, the determination unit 24 determines that the distance of the optical fiber 10 from the location of the optical fiber sensing apparatus 20 (the communication unit 21) to the location of the manhole M-B is the distance b.

Further, in the acoustic characteristic at a time when the manhole M-C is hit, the intensity of the hitting sound is equal to or higher than the threshold value at a distance c of the optical fiber 10. Therefore, the decision unit 23 decides that the manhole M-C is located on the laying route of the optical fiber 10. Further, the determination unit 24 determines that the distance of the optical fiber 10 from the location of the optical fiber sensing apparatus 20 (the communication unit 21) to the location of the manhole M-C is the distance c.

Meanwhile, in the acoustic characteristic at a time when the manhole M-D is hit, the intensity of the hitting sound is lower than the threshold value at any of each of distances of the optical fiber 10. Therefore, the decision unit 23 decides that the manhole M-D is not located on the laying route of the optical fiber 10.

As described above, among the four manholes M-A, M-B, M-C, and M-D, the manhole M decided to be located on the laying route of the optical fiber 10 is three manholes M-A, M-B, and M-C. Further, the distance of the optical fiber 10 from the location of the optical fiber sensing apparatus 20 (the communication unit 21) to the three manholes M-A, M-B, and M-C is the distance a, b, and c, respectively.

Therefore, the determination unit 24 determines the laying route of the optical fiber 10, based on the distances a, b, and c of the optical fiber 10 of each of the three manholes M-A, M-B, and M-C located on the laying route of the optical fiber 10.

Specifically, the relative magnitude relation among the distances a, b, and c of the optical fiber 10 in each of the three manholes M-A, M-B, and M-C is a<b<c.

Therefore, as illustrated in FIG. 2, the determination unit 24 determines that the laying route of the optical fiber 10 is a route of the manhole M-A-→the manhole M-B-→the manhole M-C as viewed from the optical fiber sensing apparatus 20.

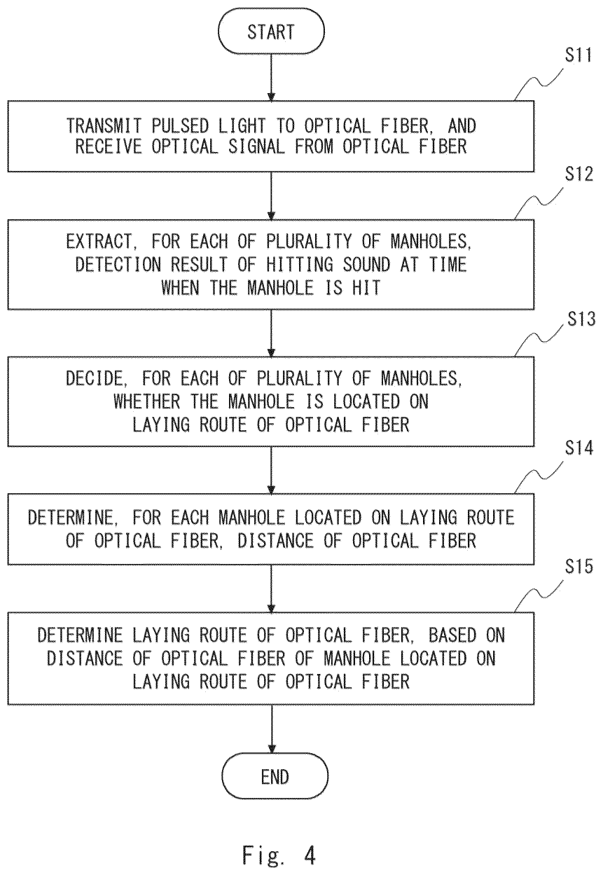

Subsequently, an example of a flow of a schematic operation of the optical fiber sensing apparatus 20 according to the first example embodiment will be described below with reference to FIG. 4.

As illustrated in FIG. 4, the communication unit 21 transmits pulsed light to the optical fiber 10, and also receives backscattered light from the optical fiber 10 as an optical signal (step S11).

In this state, for example, a user hits each of the plurality of manholes M in order with a hammer or the like.

First, the extraction unit 22 extracts, for each of the plurality of hit manholes M, a detection result of a hitting sound by the optical fiber 10 at a time when the manhole M is hit, based on the pulsed light transmitted to the optical fiber 10 by the communication unit 21 and the optical signal received from the optical fiber 10 by the communication unit 21 (step S12). At this time, for example, as a detection result of the hitting sound, the extraction unit 22 may extract an acoustic characteristic indicating intensity of the hitting sound detected by the optical fiber 10 at each distance of the optical fiber 10 from a location of the optical fiber sensing apparatus 20 (the communication unit 21) to a location where the hitting sound is detected by the optical fiber 10.

Next, the decision unit 23 decides, for each of the plurality of hit manholes M, whether the manhole M is located on a laying route of the optical fiber 10, based on the detection result of the hitting sound by the optical fiber 10 at a time when the manhole M is hit (step $13).

Next, the determination unit 24 determines, for each manhole M located on the laying route of the optical fiber 10 among the plurality of hit manholes M, the distance of the optical fiber 10 from the location of the optical fiber sensing apparatus 20 (the communication unit 21) to the location of the manhole M, based on the detection result of the hitting sound by the optical fiber 10 at a time when the manhole M is hit (step S14).

Thereafter, the determination unit 24 determines the laying route of the optical fiber 10, based on the distance of the optical fiber 10 of the manhole M located on the laying route of the optical fiber 10 (step S15). At this time, for example, the determination unit 24 may determine the laying route of the optical fiber 10, based on a relative magnitude relationship of the distance of the optical fiber 10 between the manholes M located on the laying route of the optical fiber 10.

As described above, according to the first example embodiment, the extraction unit 22 extracts, for each of the plurality of hit manholes M, a detection result of a hitting sound by the optical fiber 10 at a time when the manhole M is hit, based on pulsed light and an optical signal. The decision unit 23 decides, for each of the plurality of hit manholes M, whether the manhole M is located on the laying route of the optical fiber 10, based on the detection result of the hitting sound. The determination unit 24 determines, for each manhole M located on the laying route of the optical fiber 10, a distance of the optical fiber 10 from a location of the optical fiber sensing apparatus 20 (the communication unit 21) to a location of the manhole M, based on the detection result of the hitting sound. Furthermore, the determination unit 24 determines the laying route of the optical fiber 10, based on the distance of the optical fiber 10 of the manhole M located on the laying route of the optical fiber 10. As a result, it is possible to determine the laying route of the optical fiber 10 by using the hitting sound at a time when each of the plurality of manholes M is hit. Further, it is also possible to determine a manhole M not being located on the laying route of the optical fiber 10.

### Second Example Embodiment

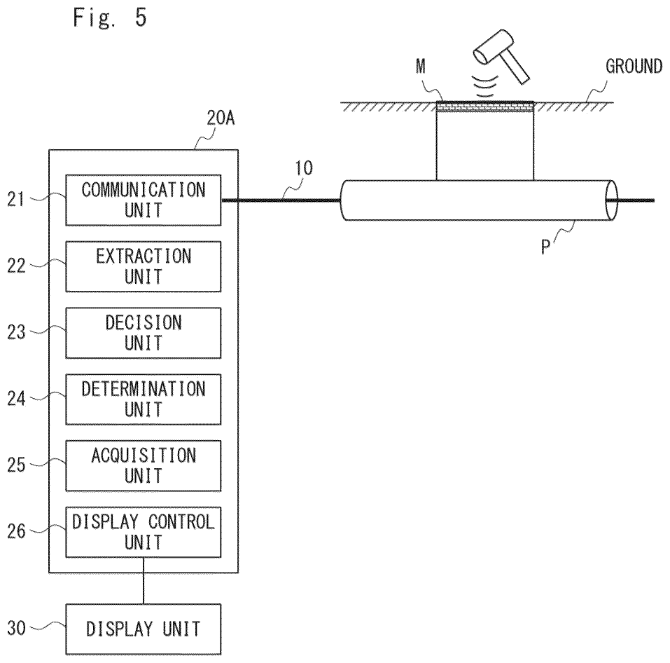

First, a configuration example of an optical fiber sensing system according to a second example embodiment will be described with reference to FIG. 5.

As illustrated in FIG. 5, the optical fiber sensing system according to the second example embodiment is different as compared with the configuration of the optical fiber sensing system according to the first example embodiment described above in FIG. 1 in that the optical fiber sensing apparatus 20 is replaced with an optical fiber sensing apparatus 20A and that a display unit 30 is added.

The display unit 30 is achieved by a display, a monitor, or the like. Note that, in the example in FIG. 5, the display unit 30 is provided outside the optical fiber sensing apparatus 20A, but is not limited thereto, and may be provided inside the optical fiber sensing apparatus 20A.

The optical fiber sensing apparatus 20A is different as compared with the optical fiber sensing apparatus 20 according to the first example embodiment in that an acquisition unit 25 and a display control unit 26 are added.

The acquisition unit 25 acquires in advance global positioning system (GPS) position information indicating latitude/longitude of each of a plurality of manholes M to be hit. At this time, for example, the acquisition unit 25 may acquire GPS position information from any external apparatus.

The display control unit 26 causes the display unit 30 to display various graphical user interface (GUI) screens. In the second example embodiment, the display control unit 26 maps a laying route of an optical fiber 10 on a map, based on the GPS position information of each of the plurality of manholes M, and causes the display unit 30 to display a GUI screen in which the laying route of the optical fiber 10 is mapped on the map. At this time, for example, it is assumed that the laying route of the optical fiber 10 is a route of a manhole M-A-→a manhole M-B-→a manhole M-C. In this case, the display control unit 26 may map the laying route of the optical fiber 10 on the map by plotting the manholes M-A, M-B, and M-C on the map, based on the GPS position information, and connecting the plots in order of the manhole M-A-→the manhole M-B-→the manhole M-C.

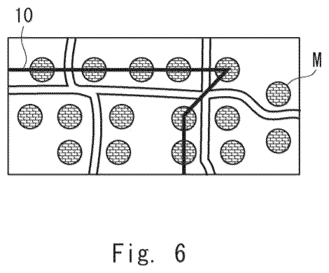

Further, the display control unit 26 may map the laying route of the optical fiber 10 and the plurality of manholes M on the map, based on the GPS position information of each of the plurality of manholes M, and cause the display unit 30 to display a GUI screen in which the laying route of the optical fiber 10 and the plurality of manholes M are mapped on the map. An example of the GUI screen in this case is illustrated in FIG. 6.

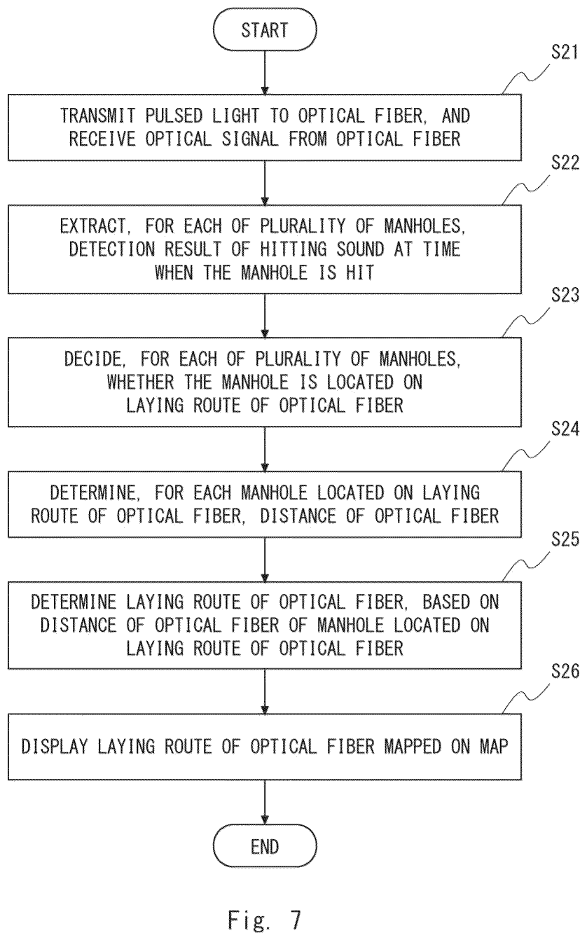

Subsequently, an example of a flow of a schematic operation of the optical fiber sensing apparatus 20A according to the second example embodiment will be described with reference to FIG. 7. Note that, in the example in FIG. 7, it is assumed that the acquisition unit 25 has already acquired the GPS position information of each of the plurality of manholes M to be hit.

As illustrated in FIG. 7, first, processing of steps S21 to S25 similar to steps S11 to S15 of the first example embodiment described above in FIG. 4 is performed.

After the processing of step S25, the display control unit 26 maps a laying route of the optical fiber 10 on a map, based on GPS position information of each of the plurality of manholes M, and causes the display unit 30 to display the laying route of the optical fiber 10 mapped on the map (step S26). At this time, for example, the display control unit 26 may map the laying route of the optical fiber 10 and the plurality of manholes M on the map, and cause the display unit 30 to display the laying route of the optical fiber 10 and the plurality of manholes M mapped on the map.

As described above, according to the second example embodiment, the display control unit 26 maps a laying route of the optical fiber 10 on a map, based on GPS position information of each of a plurality of manholes M, and causes the display unit 30 to display the laying route of the optical fiber 10 mapped on the map. As a result, a user can visually recognize on the map on what route the optical fiber 10 is laid.

Further, the display control unit 26 may map the laying route of the optical fiber 10 and the plurality of manholes M on the map, based on the GPS position information of each of the plurality of manholes M, and cause the display unit 30 to display the laying route of the optical fiber 10 and the plurality of manholes M mapped on the map. As a result, a user can also visually recognize on the map on which position the manhole M is present. Further, a user can also visually recognize a manhole M not being located on the laying route of the optical fiber 10.

Other advantageous effects are similar to those of the first example embodiment described above.

### Another Example Embodiment

In the first and second example embodiments described above, the communication unit 21, the extraction unit 22, the decision unit 23, the determination unit 24, the acquisition unit 25, and the display control unit 26 are provided in the same optical fiber sensing apparatuses 20 and 20A, but is not limited thereto, and may be arranged separately from one another. For example, the communication unit 21, the extraction unit 22, the decision unit 23, the determination unit 24, the acquisition unit 25, and the display control unit 26 may be arranged in separate apparatuses from one another. Further, the extraction unit 22, the decision unit 23, the determination unit 24, the acquisition unit 25, and the display control unit 26 may be arranged on a cloud.

### Hardware Configuration of Optical Fiber Sensing Apparatus According to Example Embodiment

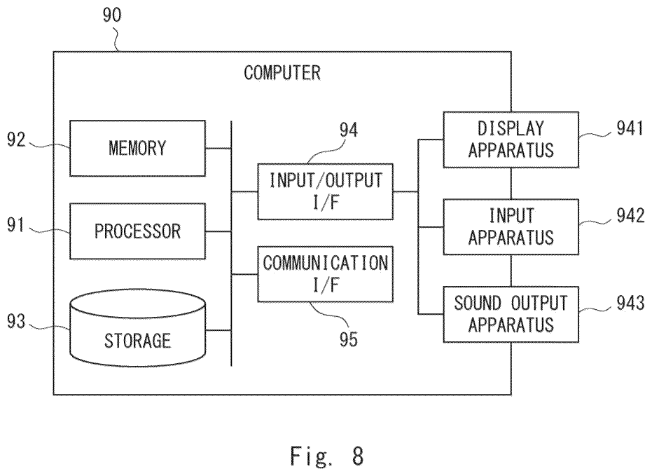

Subsequently, a hardware configuration example of a computer achieving the optical fiber sensing apparatuses 20 and 20A according to the first and second example embodiments will be described with reference to FIG. 8.

As illustrated in FIG. 8, a computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. Further, the storage 93 may be a memory such as a RAM or a ROM.

The storage 93 stores a program achieving a function of a component included in the optical fiber sensing apparatuses 20 and 20A. The processor 91 achieves the function of the component included in the optical fiber sensing apparatuses 20 and 20A by executing each of the programs. Herein, when executing each of the above-described programs, the processor 91 may read these programs from the memory 92 and execute them, or may execute these programs without reading from the memory 92. Further, the memory 92 and the storage 93 also serve to store information and data held by the component included in the optical fiber sensing apparatuses 20 and 20A.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus, such as a liquid crystal display (LCD), a cathode ray tube (CRT) display, or a monitor, that displays a screen associated to drawing data processed by the processor 91. The input apparatus 942 is an apparatus that receives an operation input from an operator, and is, for example, a keyboard, a mouse, a touch sensor, or the like. The display apparatus 941 and the input apparatus 942 may be integrated and achieved as a touch panel. The sound output apparatus 943 is an apparatus, such as a speaker, that acoustically outputs sound associated to sound data processed by the processor 91.

The communication interface 95 transmits and receives data to and from an external apparatus. For example, the communication interface 95 communicates with an external apparatus via a wired communication path or a wireless communication path.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

For example, some or all of the above-described example embodiments may be used in combination with each other.

Further, some or all of the above-described example embodiments may be described as the following supplementary notes, but is not limited thereto.

### Supplementary Note 1

An optical fiber sensing system including:
an optical fiber configured to be buried in the ground and detect a hitting sound at a time when each of a plurality of manholes is hit in order;
at least one memory configured to store an instruction group; and
at least one processor configured to execute the instruction group in such a way as to
control a communication unit in such a way as to transmit pulsed light to the optical fiber, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

### Supplementary Note 2

The optical fiber sensing system according to supplementary note 1, wherein the at least one processor is configured to execute the instruction group in such a way as to determine a laying route of the optical fiber, based on a relative magnitude relationship of a distance of the optical fiber between manholes on a laying route of the optical fiber.

### Supplementary Note 3

The optical fiber sensing system according to supplementary note 1, wherein the at least one processor is configured to execute the instruction group in such a way as to extract, as a detection result of the hitting sound, an acoustic characteristic indicating intensity of the hitting sound detected by the optical fiber at each distance of the optical fiber from a location of the communication unit to a location where the hitting sound is detected by the optical fiber.

### Supplementary Note 4

The optical fiber sensing system according to supplementary note 1, wherein the at least one processor is configured to execute the instruction group in such a way as to
acquire in advance global positioning system (GPS) position information of each of the plurality of manholes, and
map a laying route of the optical fiber on a map, based on GPS position information of each of the plurality of manholes, and cause a display unit to display a laying route of the optical fiber mapped on the map.

### Supplementary Note 5

The optical fiber sensing system according to supplementary note 4, wherein the at least one processor is configured to execute the instruction group in such a way as to map a laying route of the optical fiber and the plurality of manholes on a map, based on GPS position information of each of the plurality of manholes, and cause the display unit to display a laying route of the optical fiber and the plurality of manholes mapped on the map.

### Supplementary Note 6

An optical fiber sensing apparatus including:
at least one memory configured to store an instruction group; and
at least one processor configured to execute the instruction group in such a way as to
control a communication unit in such a way as to transmit pulsed light to an optical fiber configured to be buried in the ground and detect a hitting sound at a time when each of a plurality of manholes is hit in order, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

### Supplementary Note 7

The optical fiber sensing apparatus according to supplementary note 6, wherein the at least one processor is configured to execute the instruction group in such a way as to determine a laying route of the optical fiber, based on a relative magnitude relationship of a distance of the optical fiber between manholes on a laying route of the optical fiber.

### Supplementary Note 8

The optical fiber sensing apparatus according to supplementary note 6, wherein the at least one processor is configured to execute the instruction group in such a way as to extract, as a detection result of the hitting sound, an acoustic characteristic indicating intensity of the hitting sound detected by the optical fiber at each distance of the optical fiber from a location of the communication unit to a location where the hitting sound is detected by the optical fiber.

### Supplementary Note 9

The optical fiber sensing apparatus according to supplementary note 6, wherein the at least one processor is configured to execute the instruction group in such a way as to
acquire in advance global positioning system (GPS) position information of each of the plurality of manholes, and
map a laying route of the optical fiber on a map, based on GPS position information of each of the plurality of manholes, and cause a display unit to display a laying route of the optical fiber mapped on the map.

### Supplementary Note 10

The optical fiber sensing apparatus according to supplementary note 9, wherein the at least one processor is configured to execute the instruction group in such a way as to map a laying route of the optical fiber and the plurality of manholes on a map, based on GPS position information of each of the plurality of manholes, and cause the display unit to display a laying route of the optical fiber and the plurality of manholes mapped on the map.

### Supplementary Note 11

A route determination method by an optical fiber sensing apparatus, the method including:
a communication step of transmitting pulsed light to an optical fiber configured to be buried in the ground and detect a hitting sound at a time when each of a plurality of manholes is hit in order, and also receiving an optical signal from the optical fiber;
an extraction step of extracting, for each of the plurality of manholes, a detection result of the hitting sound by the optical fiber at a time when the manhole is hit, based on the pulsed light and the optical signal;
a decision step of deciding, for each of the plurality of manholes, whether the manhole is located on a laying route of the optical fiber, based on a detection result of the hitting sound at a time when the manhole is hit; and
a determination step of determining, for each manhole located on a laying route of the optical fiber, a distance of the optical fiber from a location of the optical fiber sensing apparatus to a location of the manhole, based on a detection result of the hitting sound at a time when the manhole is hit, and determining a laying route of the optical fiber, based on a distance of the optical fiber of a manhole on a laying route of the optical fiber.

### Supplementary Note 12

The route determination method according to supplementary note 11, wherein, in the determination step, a laying route of the optical fiber is determined based on a relative magnitude relationship of a distance of the optical fiber between manholes on a laying route of the optical fiber.

### Supplementary Note 13

The route determination method according to supplementary note 11, wherein, in the extraction step, an acoustic characteristic indicating intensity of the hitting sound detected by the optical fiber is extracted, as a detection result of the hitting sound, at each distance of the optical fiber from a location of the optical fiber sensing apparatus to a location where the hitting sound is detected by the optical fiber.

### Supplementary Note 14

The route determination method according to supplementary note 11, further including:
an acquisition step of acquiring in advance global positioning system (GPS) position information of each of the plurality of manholes; and
a display control step of mapping a laying route of the optical fiber on a map, based on GPS position information of each of the plurality of manholes, and causing a display unit to display a laying route of the optical fiber mapped on the map.

### Supplementary Note 15

The route determination method according to supplementary note 14, wherein, in the display control step, a laying route of the optical fiber and the plurality of manholes are mapped on a map, based on GPS position information of each of the plurality of manholes, and a laying route of the optical fiber and the plurality of manholes mapped on the map are displayed on the display unit.

What is claimed is:

1. An optical fiber sensing system comprising:
an optical fiber configured to be buried in the ground and detect a hitting sound at a time when each of a plurality of manholes is hit in order;
at least one memory configured to store an instruction group; and
at least one processor configured to execute the instruction group in such a way as to
control a communication unit in such a way as to transmit pulsed light to the optical fiber, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

2. The optical fiber sensing system according to claim 1, wherein the at least one processor is configured to execute the instruction group in such a way as to determine a laying route of the optical fiber, based on a relative magnitude relationship of a distance of the optical fiber between manholes on a laying route of the optical fiber.

3. The optical fiber sensing system according to claim 1, wherein the at least one processor is configured to execute the instruction group in such a way as to extract, as a detection result of the hitting sound, an acoustic characteristic indicating intensity of the hitting sound detected by the optical fiber at each distance of the optical fiber from a location of the communication unit to a location where the hitting sound is detected by the optical fiber.

4. The optical fiber sensing system according to claim 1, wherein the at least one processor is configured to execute the instruction group in such a way as to
acquire in advance global positioning system (GPS) position information of each of the plurality of manholes, and
map a laying route of the optical fiber on a map, based on GPS position information of each of the plurality of manholes, and cause a display unit to display a laying route of the optical fiber mapped on the map.

5. The optical fiber sensing system according to claim 4, wherein the at least one processor is configured to execute the instruction group in such a way as to map a laying route of the optical fiber and the plurality of manholes on a map, based on GPS position information of each of the plurality of manholes, and cause the display unit to display a laying route of the optical fiber and the plurality of manholes mapped on the map.

6. An optical fiber sensing apparatus comprising:
at least one memory configured to store an instruction group; and
at least one processor configured to execute the instruction group in such a way as to
control a communication unit in such a way as to transmit pulsed light to an optical fiber configured to be buried in the ground and detect a hitting sound at a time when each of a plurality of manholes is hit in order, and also receive an optical signal from the optical fiber,
extract, for each of the plurality of manholes, a detection result of the hitting sound by the optical fiber at a time when the manhole is hit, based on the pulsed light and the optical signal,
decide, for each of the plurality of manholes, whether the manhole is located on a laying route of the optical fiber, based on a detection result of the hitting sound at a time when the manhole is hit, and
determine, for each manhole located on a laying route of the optical fiber, a distance of the optical fiber from a location of the communication unit to a location of the manhole, based on a detection result of the hitting sound at a time when the manhole is hit, and determine a laying route of the optical fiber, based on a distance of the optical fiber of a manhole on a laying route of the optical fiber.

7. The optical fiber sensing apparatus according to claim 6, wherein the at least one processor is configured to execute the instruction group in such a way as to determine a laying route of the optical fiber, based on a relative magnitude relationship of a distance of the optical fiber between manholes on a laying route of the optical fiber.

8. The optical fiber sensing apparatus according to claim 6, wherein the at least one processor is configured to execute the instruction group in such a way as to extract, as a detection result of the hitting sound, an acoustic characteristic indicating intensity of the hitting sound detected by the optical fiber at each distance of the optical fiber from a location of the communication unit to a location where the hitting sound is detected by the optical fiber.

9. The optical fiber sensing apparatus according to claim 6, wherein the at least one processor is configured to execute the instruction group in such a way as to
acquire in advance global positioning system (GPS) position information of each of the plurality of manholes, and
map a laying route of the optical fiber on a map, based on GPS position information of each of the plurality of manholes, and cause a display unit to display a laying route of the optical fiber mapped on the map.

10. The optical fiber sensing apparatus according to claim 9, wherein the at least one processor is configured to execute the instruction group in such a way as to map a laying route of the optical fiber and the plurality of manholes on a map, based on GPS position information of each of the plurality of manholes, and cause the display unit to display a laying route of the optical fiber and the plurality of manholes mapped on the map.

11. A route determination method by an optical fiber sensing apparatus, the method comprising:
a communication step of transmitting pulsed light to an optical fiber configured to be buried in the ground and detect a hitting sound at a time when each of a plurality of manholes is hit in order, and also receiving an optical signal from the optical fiber;
an extraction step of extracting, for each of the plurality of manholes, a detection result of the hitting sound by the optical fiber at a time when the manhole is hit, based on the pulsed light and the optical signal;
a decision step of deciding, for each of the plurality of manholes, whether the manhole is located on a laying route of the optical fiber, based on a detection result of the hitting sound at a time when the manhole is hit; and
a determination step of determining, for each manhole located on a laying route of the optical fiber, a distance of the optical fiber from a location of the optical fiber sensing apparatus to a location of the manhole, based on a detection result of the hitting sound at a time when the manhole is hit, and determining a laying route of the optical fiber, based on a distance of the optical fiber of a manhole on a laying route of the optical fiber.

12. The route determination method according to claim 11, wherein, in the determination step, a laying route of the optical fiber is determined based on a relative magnitude relationship of a distance of the optical fiber between manholes on a laying route of the optical fiber.

13. The route determination method according to claim 11, wherein, in the extraction step, an acoustic characteristic indicating intensity of the hitting sound detected by the optical fiber is extracted, as a detection result of the hitting sound, at each distance of the optical fiber from a location of the optical fiber sensing apparatus to a location where the hitting sound is detected by the optical fiber.

14. The route determination method according to claim 11, further comprising:
an acquisition step of acquiring in advance global positioning system (GPS) position information of each of the plurality of manholes; and
a display control step of mapping a laying route of the optical fiber on a map, based on GPS position information of each of the plurality of manholes, and causing a display unit to display a laying route of the optical fiber mapped on the map.

15. The route determination method according to claim 14, wherein, in the display control step, a laying route of the optical fiber and the plurality of manholes are mapped on a map, based on GPS position information of each of the plurality of manholes, and a laying route of the optical fiber and the plurality of manholes mapped on the map are displayed on the display unit.
